(19) United States
(12) Patent Application Publication
(10) Pub. No.: US 2008/0187644 A1
(43) Pub. Date: Aug. 7, 2008

(54) FERMENTED ALCOHOLIC BEVERAGE EXCELLENT IN COLOR LEVEL AND FLAVOR AND METHOD OF PRODUCING THE SAME

(75) Inventors: Takehito Ota, Tokyo (JP); Nobuyoshi Sasaki, Tokyo (JP)

Correspondence Address: DARBY & DARBY P.C., P.O. BOX 770, Church Street Station, New York, NY, 10008-0770, US

(73) Assignee: KIRIN BEER KABUSHIKI KAISHA, Tokyo (JP)

(21) Appl. No.: 12/013,723

(22) Filed: Jan. 14, 2008

Related U.S. Application Data
(63) Continuation of application No. 11/964,983, filed on Dec. 27, 2007.
Application No. 11/964,983 is a continuation-in-part of application No. 11/721,935, filed on Dec. 31, 2007.

(30) Foreign Application Priority Data
Dec. 16, 2004 (JP) 2004-364837
Feb. 7, 2005 (JP) 2005-031154

(51) Int. Cl. C12H 1/00

(52) U.S. Cl. 426/592

(57) ABSTRACT

A fermented non-“beer” alcoholic beverage that is imparted a beer-like, natural color level and flavor and a method for producing the same are provided in a fermented alcoholic beverage that uses brewer's yeast and a method for producing the same. A fermented non-“beer” alcoholic beverage that is imparted a beer-like, natural color level and flavor may be produced without using artificial colorings such as caramel by adjusting the liquid color and flavor of the fermented alcoholic beverage using Maillard reaction products of sugar and proteolytic products and a preparation of the same. The method for producing a fermented alcoholic beverage of the present invention may be used in particular in producing “low-malt beer” and “other miscellaneous liquors” that require enhancement of the color level and flavor of the fermented alcoholic beverage because of restrictions on the use of fermentation ingredients, namely, wheat, barley and their malts.

### CROSS REFERENCE TO PRIOR APPLICATIONS

This application is a continuation of U.S. patent application Ser. No. 11/964,983, filed Dec. 27, 2007, which is a continuation-in-part of U.S. patent application Ser. No. 11/721,935, filed Dec. 31, 2007, which is a U.S. National Phase Application under 35 U.S.C. §371 of International Application No. PCT/JP2005/023178, filed Dec. 16, 2005, which claims the benefit of Japanese Patent Application No. 2004-364837, filed Dec. 16, 2004, and Japanese Patent Application No. 2005-031154, filed Feb. 7, 2005, all of which are incorporated by reference herein in their entirety.

### FIELD OF THE INVENTION

The present invention relates to a fermented alcoholic beverage excellent in color of the liquid and in flavor; and to a method for producing the fermented alcoholic beverage in which Maillard reaction products of sugar and proteolytic products are used to adjust the color level (color of the liquid) and flavor of the fermented alcoholic beverage in a method for producing a fermented alcoholic beverage using brewer's yeast.

### BACKGROUND OF THE INVENTION

Beer and low-malt beer, which are fermented alcoholic beverages, are produced with: malt as the main ingredient; a starchy ingredient such as rice, barley, wheat, corn or starch as a secondary ingredient; and hops and water as further ingredients. Under the Japanese Liquor Tax Law, these malt-based beverages are classified into four types according to their malt content excluding water: not less than 66.7% by weight; not less than 50% by weight and less than 66.7% by weight; not less than 25% by weight and less than 50% by weight; and less than 25% by weight. The term “beer” refers to the tax category with the highest malt content (i.e., ≧66.7%). The term “low-malt beer” (or “happoushu” in Japanese) is used to refer to the remaining three categories. Since a category with a higher malt content is taxed at a higher rate, beverages belonging to lower categories can generally be sold at lower retail prices.

Under the Japanese Liquor Tax Law, low-malt beer belongs to a class of “miscellaneous liquors” that use barley, wheat or their malts as part of their ingredients. The term “miscellaneous liquors” is defined under Japanese Law to mean liquors that do not belong to any of the following defined categories: “sake,” “sake compound,” “shochu,” “mirin,” “beer,” “wines,” “whiskies,” “spirits,” and “liqueurs.” Both beer and low-malt beer have in common the use of active enzymes of malt or purified enzymes derived from molds or the like to saccharify malt or starchy component used as secondary ingredient, with this saccharified liquid fermented and broken down into alcohol and carbon dioxide gas to make an alcoholic beverage. Therefore, the method for making beer and the method for making low-malt beer do not differ greatly in their fundamentals.

On the other hand, “miscellaneous liquors” that have sparkling characteristics, namely, fermented “miscellaneous liquors”, are divided under the Japanese Liquor Tax Law into: the “low-malt beer” described above that uses barley, wheat or their malts as part of its ingredients; and “other miscellaneous liquors” aside from low-malt beer. Here, the “other miscellaneous liquors” are ones that do not use barley, wheat or their malts but in which vegetable proteins or the like such as pulses (i.e., peas, beans, lentils, etc.) or grains are broken down with enzymes to obtain required nitrogen sources and saccharified liquid is added to carry out fermentation. Therefore, there are also fundamentally no great differences in the way the “other miscellaneous liquors” are made from the way “beer” or “low-malt beer” is made, and it is possible to make them using the production equipment for beer or low-malt beer.

In recent years, various ingredients and various additives have been used in fermented alcoholic beverages, such as “beer,” “low-malt beer” and “other miscellaneous liquors” with sparkling characteristics, for such purposes as increasing the variations in flavor, and methods for producing fermented alcoholic beverages having a variety of tastes and flavors have been disclosed. For beverages that use ingredients other than malt, for example, a method is disclosed in which wort is prepared from glucose syrup based on starch obtained from wheat, potatoes, corn, sorghum, barley, rice, or tapioca, and from soluble proteins, water, and hops. This wort is fermented to produce beer-type beverages (Published Japanese Unexamined Patent Application No. 2001-37462). A method for producing low-alcohol fermented beverages with grains such as rice, wheat, barnyard grass, or millet as the ingredients has also been disclosed (Published Japanese Unexamined Patent Application No. 2001-37463).

In all methods for producing these fermented alcoholic beverages, techniques are adopted in which the ingredients are mixed to prepare a pre-fermentation solution and this pre-fermentation solution is heated and boiled to deactivate the enzymes and adjust the color level, after which brewer's yeast is used to carry out fermentation. In the production of “beer” among fermented alcoholic beverages that are fermented using brewer's yeast, the color level (color of the liquid) is imparted mainly by the pigment of the malt, and adjustment of the color level (color of the liquid) of the fermented alcoholic beverage is attempted by adding a pigment as necessary. However, with “low-malt beer” and “other miscellaneous liquors,” a decrease in the color level of the final product based on restrictions on the use of the ingredients cannot be avoided because either the proportion of malt used is low or there is a restriction on the proportion of barley, wheat or their malts that may be used, and the color level (color of the liquid) of the fermented alcoholic beverage is adjusted, among others, by adding pigments such as caramel coloring. Here, a favorable liquid color refers to the bright golden yellow color characteristic of beer and which imparts to it a positive attribute as a consumer product.

For example, Published Japanese Unexamined Patent Application No. 2001-37462 discloses a method for producing a beer-type beverage in which no malt is used. A wort is prepared using soluble protein ingredients prepared from glucose syrup, wheat protein or the like, and caramel is used to impart its color level. In addition, Published Japanese Unexamined Patent Application No. 2004-24151 discloses a method for producing a beverage with a beer taste without using malt as an ingredient, by using wheat starch ingredients such as barley and wheat. Caramel, safflower coloring or caramel and safflower coloring is added to adjust the color level.

Furthermore, WO 2004/000990 discloses a method for producing a sparkling beer-like alcoholic beverage without using any barley, wheat, or malt, and using a syrup containing a carbon source obtained from corn, potatoes, green peas, soybeans or rice and a nitrogen source obtained from corn, potatoes, green peas, soybeans or rice. Coloring is added to give this alcoholic beverage the desired color level, and cited among various colorings are caramel coloring, safflower coloring, gardenia coloring, kaoliang coloring, cochineal coloring, carrot coloring, paprika coloring, red cabbage coloring, grape coloring, purple corn coloring, elderberry coloring, beet coloring, ang-kahk coloring, turmeric coloring, and other natural colorings, or synthetic coloring such as red dye 102 for food, red dye 104 for food and orange dye 201. However, in methods in which these colorings are added, the tendency toward alcoholic beverages with unnatural colors or tastes differing from beer remains. With the restrictions on the use of barley, wheat or their malts ingredients, there is a lack of the taste and feeling of body that exist in beer, and the tendency toward a feeling of something missing was strong.

The Maillard reaction is well-known as a reaction between the sugars and free amino acids contained in food products and the like, when high temperatures are applied as in cooking, roasting, or baking, as when preparing or manufacturing the food products and the like. In the Maillard reaction, the amino group of an amino acid, which acts as a necleophile, and the carbonyl group of a sugar molecule go through dehydration condensation to produce a glycosylamine. Glycosylamines, being unstable, further undergo a rearrangement to become ketosamines. Ketosamines then usually polymerize to form brown pigments. The Maillard reaction products that are produced by the reaction impart color and aroma to the food products and the like. The Maillard reaction products are known for being used to give flavor to food products and the like by taking advantage of the characteristics of these reaction products (Published Japanese Application No. 2004-511241). Their use as an antioxidant utilized in food products and the like is known as a special application outside their utility for imparting color, aroma, or flavor (Published Japanese Unexamined Patent Application No. S56-166286). However, direct use of these reaction products to actively impart flavor and color to fermented alcoholic beverages is not known.

First, use of caramel malt and caramel colorant in beer maintains the original/unique flavor of beer, and the color of beer can be controlled appropriately. As to the current trend for alcoholic beverages, people tend to prefer a light beer. In this regard, it is possible even for the “low-malt beer (happoushu),” which has a limited malt content, to control the beverage to have a beer-like color and beer-like yet refreshing flavor by using the caramel malt and caramel colorant The current law allows, under the category with the lowest malt content, up to 25% malt content). Therefore, there is no need to “forcibly” add color or richness in flavor by applying pressure to forcibly cause the Maillard reaction to occur. However, in order to add a beer-like color and beer-like taste to a beverage which belongs to a new genre of malt free beverages the method of the invention can be applied to a part or some of the “low malt content beer (happoushu).” This technique can be applied to no-malt beer (i.e., “other miscellaneous liquors”) and “low malt beer” as well. For example, in order to increase the fermentation degree, the described method is employed in the “low malt content beer (happoushu)” in which its malt content is kept as low as possible, to add the beer-like color and beer-like taste. In this Maillard reaction, the reaction is forced and controlled, and thus deviates from the normal beer brewing process. In this way, less malt can be used. Further details on the Maillard reaction and its products can be found, for example, in MALTING and BREWING SCIENCE, Volume 2, HOPPED WORT and BEER, J. S. Hough, D. E. Briggs, R. Stevens, and T. W. Young, “Malting and Brewing Science, Volume 2, Hopped Wort and Beer,” second edition, Aspen Publishers, Inc. (1999), pp. 462-64, whose contents are incorporated by reference herein.

### DISCLOSURE OF THE INVENTION

The problem for the present invention is, in a fermented alcoholic beverage that uses brewer's yeast and a method for producing the same, to provide a fermented non-“beer” alcoholic beverage that is given a beer-like, natural color level and flavor. In particular, the problem is to provide a fermented non-“beer” alcoholic beverage that is given a beer-like, natural color level and flavor and a method for producing the same in “low-malt beer” and “other miscellaneous liquors” that require enhancement in the color level and flavor of the fermented alcoholic beverages because of restrictions on the use of fermentation ingredients barley, wheat or their malts.

Conventionally, in fermented alcoholic beverages that use brewer's yeast, and more specifically, in fermented alcoholic beverages such as “low-malt beer” and “other miscellaneous liquors,” artificial colors such as caramel are added to enhance the color level and flavor of these fermented alcoholic beverages. However, in methods in which these artificial colors (pigments) are added to alcoholic beverages, the tendency toward alcoholic beverages with unnatural colors or flavors differing from “beer” remains, and there was a problem in that it was difficult to produce non-“beer” fermented alcoholic beverages that were given a beer-like, natural color level and flavor In a case where the caramel colorant is used, the color is forcibly added thus not relevant to the above process. If the colorant is not used, it is relevant in regards to the Maillard reaction.

The present invention is concerned with the adjustment of color level and flavor of fermented alcoholic beverages in the production of fermented alcoholic beverages using brewer's yeast. More specifically, the invention is concerned with adjusting the color level and flavor of “low-malt beer” and “other miscellaneous liquors” that require enhancement in the color level and flavor of fermented alcoholic beverages because of restrictions on the use of fermentation ingredients, such as the use of barley, wheat or their malts. The present inventors, in specific investigations into methods for producing fermented non-“beer” alcoholic beverages that are given beer-like, natural color levels and flavors, have discovered that fermented non-“beer” alcoholic beverages having beer-like, natural color levels and flavors can be produced without using artificial colors such as caramel, which has been used conventionally. According to the invention, the color of the liquid and flavor of the fermented alcoholic beverage can be adjusted by using Maillard reaction products of sugar and amino acids derived from proteolytic products or preparations of the same.

In what follows, for clarity of description, the term “starting materials” is used to refer to the initial reactants in the Maillard reaction, and the term “original ingredients” is used to refer to the initial reactants in the process of producing a fermented alcoholic beverage. In the present invention, for the starting materials (sugar and proteolytic products) used in preparing Maillard reaction products, decomposition products of the starches that are used as the original ingredients in the production of fermented alcoholic beverages using brewer's yeast can be used as the sugar source. Decomposition products of proteins can be used as the proteolytic products. In addition, for the purpose of achieving a balance between the flavor imparted by the addition of Maillard reaction products and the flavor of the fermented alcoholic beverage imparted by the proteins used as the original ingredients, decomposition products of the protein ingredients that are originally used as nitrogen sources in the production of that fermented alcoholic beverage may be used as the proteolytic products used in preparing the Maillard reaction products in the present invention. In the present invention, decomposition products of soybean protein may be cited as particularly preferable proteolytic products for the proteolytic products used in preparing the Maillard reaction products.

In the present invention, the Maillard reaction products may be prepared by reacting sugar and proteolytic products at a reaction temperature of not less than 105° C. and not more than 121° C., preferably not less than 105° C. and not more than 121° C., and more preferably not less than 110° C. and not more than 115° C. The reaction pressure is in the range of 0.02 MPa to 0.1 MPa, preferably in the range of 0.04 MPa to 0.1 MPa, and more preferably in the range of 0.07 MPa to 0.1 MPa. The reaction time is in the range of 50 mins to 120 mins, preferably in the range of 50 mins to 90 mins, and more preferably in the range of 50 mins to 70 mins. In addition, preparations in which the Maillard reaction products are prepared in advance and formed into solid (e.g., a substance without water or having any absence of water) produced by drying, powdering and the like, such as through freeze-drying, sunlight, aeration, overheating/superheating, vacuum, atomization/nebulization, infra-red, high-frequency drying, or any other method known by one of ordinary skill in the art, may be used in the present invention. Purification or separation steps are utilized as appropriate or necessary along the way. In the processes for producing the fermented alcoholic beverage of the present invention, the Maillard reaction products are added before the fermentation process in the process for producing the fermented alcoholic beverage.

Alternatively, a process for producing the Maillard reaction products with the sugar and proteolytic products using a reaction temperature of not less than 105° C. and not more than 121° C. may be inserted before the fermentation process in the production process of the fermented alcoholic beverage. Preferably the temperature in this “process insertion” case is not less than 110° C. and not more than 121° C., and more preferably not less than 115° C. and not more than 121° C. The reaction pressure is in the range of 0.02 MPa to 0.1 MPa, preferably in the range of 0.04 MPa to 0.1 MPa, and more preferably in the range of 0.07 MPa to 0.1 MPa. The reaction time is in the range of 50 mins to 120 mins, preferably in the range of 50 mins to 90 mins, and more preferably in the range of 50 mins to 70 mins.

Thus, the present invention specifically encompasses (1) a method for producing a fermented alcoholic beverage that uses brewer's yeast, wherein Maillard reaction products of sugar and proteolytic products or preparations of the same are used to adjust the liquid color and flavor of the fermented alcoholic beverage; (2) the method for producing a fermented alcoholic beverage described in (1) above, wherein the proteolytic products are decomposition products of the proteins that are used as the original nitrogen ingredients in producing the fermented alcoholic beverage; (3) the method for producing a fermented alcoholic beverage described in (1) or (2) above, wherein the proteolytic products are soybean proteolytic products; (4) the method for producing a fermented alcoholic beverage described in any of (1)-(3) above, wherein the reaction temperature for the Maillard reaction between sugar and the proteolytic products is not less than 105° C. and not greater than 121° C.; (5) the method for producing a fermented alcoholic beverage described in any of (1)-(4) above, wherein the Maillard reaction products of the sugar and proteolytic products are added before the fermentation process in the process for producing the fermented alcoholic beverage; (6) the method for producing a fermented alcoholic beverage described in any of (1)-(4) above, wherein a process for producing Maillard reaction products from the sugar and proteolytic products in the original ingredients using a reaction temperature of not less than 105° C. and not more than 121° C. is inserted before the fermentation process in the process for producing the fermented alcoholic beverage; and (7) the method for producing a fermented alcoholic beverage described in any of (1)-(6) above, wherein the fermented alcoholic beverage is a “low-malt beer” or “other miscellaneous liquor.”

In addition, the present invention includes (8) a fermented alcoholic beverage excellent in liquid color and flavor produced by the fermented alcoholic beverage production method described in any of (1)-(7) above.

The present invention concerns adjusting the liquid color and flavor of a fermented alcoholic beverage using the Maillard reaction products of sugar and proteolytic products, or a preparation of the same, in a method for producing a fermented alcoholic beverage using brewer's yeast. The Maillard reaction products are brown substances obtained in a solution state by mixing and heating proteolytic products such as amino acids and sugar in water, and have an aroma that is imparted by the thermal reaction of proteolytic products such as amino acids and sugar.

Of the starting materials used for producing the Maillard reaction products, the sugar component has no limitations as long as it contains sugars such as crystallized glucose, starch syrup, or other liquid sugar syrups, or saccharified liquid of malt, wheat, rice, or other vegetable starches and the like, but liquid sugar syrups are preferable from the standpoint of being easy to handle and making the reaction efficient. In addition, since the sugar hydroxyl groups having the capacity to form glycosides are part of what promotes the Maillard reaction, it is more preferable to use liquid sugar syrups primarily of monosaccharides.

In addition, of the starting materials that undergo the Maillard reaction, decomposition products of the proteins contained in grains, legumes, corn, potatoes, rice and the like by protease or peptidase may be used for the proteolytic products. Industrially purified amino acids or mixtures thereof may be used as well. From the standpoint of cost and flavor, the former (the decomposition products of natural proteins), which are used as the original ingredients for producing fermented alcoholic beverages that use brewer's yeast, are preferable. Furthermore, among the former, decomposition products of soybean proteins may be cited as more preferable proteolytic products. In addition, for the purpose of achieving a balance between the flavor imparted by the addition of Maillard reaction products and the flavor of the fermented alcoholic beverage imparted by the proteins used as the original ingredients, decomposition products of the protein ingredients that are originally used as nitrogen sources in producing the fermented alcoholic beverage may be used as the proteolytic products in preparing the Maillard reaction products in the present invention. In the present invention commercial enzymes may be used as the enzymes for breaking down the proteins in preparing the proteolytic products. For example, any of protease A Amano G, protease P Amano G, peptidase R (Amano Enzyme Inc.) or the like may be used as the enzyme, and these enzymes may be combined as well.

In the present invention, it is preferable for the reaction temperature used in preparing the Maillard reaction products to be high from the standpoint of reducing the reaction time, but if it is excessively high, the sugar itself will undergo a caramelization reaction, and the target color tone or flavor will not be obtained. On the other hand, if the reaction temperature is too low, the Maillard reaction will not proceed at a reasonable rate. Therefore, it is preferable that a temperature of 105° C. to 121° C. be adopted, more preferably 110 to 121° C., and still more preferably 115° C. to 121° C. It is preferable that the reaction pressure range between 0.02-0.1 MPa 0.04-0.1 MPa and 0.07-0.1 MPa. Also preferably the reaction time can vary between 50-120 mins, 50-90 mins, and 50-70 mins. In the method for producing the fermented alcoholic beverage of the present invention, the timing for adding the Maillard reaction products is not limited in particular, but to make the sugar and amino acids remaining in the Maillard reaction products be consumed by the yeast, it is preferable for them to be added at a stage before fermentation. In other words, in the present invention, the Maillard reaction products are prepared in advance and added before the fermentation process in the process for producing the fermented alcoholic beverage.

Alternatively, this may be done by inserting a Maillard reaction step using a reaction temperature of not less than 105° C. and not more than 121° C., to produce the Maillard reaction products of the sugars and proteolytic products contained in the original ingredients before the fermentation process in the process for producing the fermented alcoholic beverage. The reaction temperature in this “process insertion” case is more preferably not less than 105° C. and not more than 121° C., or 110-121° C. and still more preferably not less than 115° C. and not more than 121° C. Reaction pressure can vary from 0.02-0.1 MPa, 0.04-0.1 MPa and/or 0.07-0.1 MPa (The reaction time can vary from 50-120 mins, 50-90 mins and/or 50-70 mins. Reaction pressure is proportional to reaction temperature while the reaction temperature is in inverse proportion to reaction time. It is likely that caramelization does not occur if the temperature is kept below a certain point. The simplest method to control how much of the sugars and proteolytic products contained in the original ingredients are consumed by the Maillard process is to control by color of the product. Controlling the amounts of nitrogen and α-Amino nitrogen is also possible but is not as simple or convenient.

When a fermented alcoholic beverage is produced using the production method of the present invention, the liquid color and flavor of the fermented alcoholic beverage may be adjusted by using, as a proxy index or indices, any one or more of the color level, the furfural component, the methional component, or the phenylacetaldehyde component of the Maillard reaction products or the preparation of the same. Here, color level is measured in units of EBC (“European Brewing Convention”) based on a system used to quantify the color intensity or darkness of a beer or malted grain. Further details on EBC can be found, for example, in EBC-ANALYTICA, EBC Analysis Committee, “European Brewery Convention: Analytica-EBC,” Verlag Hans Carl Gertranke-Fachverlag (1998), the contents of which are incorporated by reference herein. Furfural, methional, and phenylacetaldehyde are known to be among the most common aldehyde compounds produced in the Maillard reaction (See EBC-ANALYTICA). When the liquid color and flavor of the fermented alcoholic beverage are adjusted using any one or more of the color level, the furfural component, the methional component, or the phenylacetaldehyde component of the Maillard reaction products or the preparation of the same as a proxy index or indices for the adjustment of the liquid color and flavor of the fermented alcoholic beverage, it is preferable for the numerical values of the color level described above or of the concentrations of the various components described above to be: 12EBC or greater for said color level; 300 ppb or greater for said furfural component concentration; 50 ppb or greater for said methional component concentration; or 200 ppb or greater for said phenylacetaldehyde component concentration. Color is one of the main indicators to determine the right mixing ratio of the Maillard reaction products with the target fermented alcoholic beverage. The effects of the (raw) materials are negligible, allowing the Maillard reaction to be controllable.

In other words, it is sufficient for the color level or the concentration of aldehydes (furfural, methional, and phenylacetaldehyde) of the Maillard reaction products, using which it is possible indirectly to adjust the liquid color and flavor of the fermented alcoholic beverage effectively and efficiently, to be at least twice as much or more as in the case of normal Maillard reaction products such as obtained at a conventionally utilized retention temperature of 100° C. and ambient pressure. Specifically, it is sufficient as described above for the color level to be 12EBC or greater, the furfural component concentration to be 300 ppb or greater, the methional component concentration to be 50 ppb or greater, or the phenylacetaldehyde component concentration to be 200 ppb or greater. It is more preferable for them to be four times or more than those of the normal Maillard reaction products, that is, it is sufficient for the color level to be 23EBC or greater, the furfural component concentration to be 600 ppb or greater, the methional component concentration to be 100 ppb or greater, or the phenylacetaldehyde component concentration to be 400 ppb or greater. It is even more preferable for the color level to be 39EBC or greater, the furfural component concentration to be 900 ppb or greater, the methional component concentration to be 200 ppb or greater, or the phenylacetaldehyde component concentration to be 700 ppb or greater. At the same time, the furfural, methional, or phenylacetaldehyde concentration cannot be excessively high because by controlling the amount of raw materials to be input and controlling the reaction speed with temperature and time, the concentrations of furfural and others do not become excessively high. In other words, optimal ranges exist for the concentrations of these components.

In the present invention, a pressurized heating device may be used as the device for preparing the Maillard reaction products. For the method for producing the fermented alcoholic beverage of the present invention, the production equipment normally used in producing beer or the like may be used, and for the production conditions such as the conditions for preparing, processing, and fermenting wort or pre-fermentation solution, the conditions normally used in producing these fermented alcoholic beverages may basically be used.

As a contrasting example the normal process for beer is that crushed malt (90%) is dissolved in 250 ml of hot water and is left for 30 mins at 50° C. and for 40 mins at 65° C., then the wort is filtered. Next, about 0.5 kg of hop is added in the wort, the wort is boiled at 100° C. for 90 mins then is adjusted/diluted with 500 ml of hot water. After the liquid is cooled, 2 kg of yeast is added thereto and the liquid is fermented at 12° C. for seven days. Finally, it is aged/matured at 10° C. for about a month. The Equipment used for “process insertion” is a pressure cooker which is an autoclave container/pot that has a temperature of 100° C. or higher when pressure is applied thereto.

Further specific descriptions of the present invention will be given in the following embodiments, but the scope of the present invention is not limited to or by these examples.

### EMBODIMENT 1

### Method for Producing Maillard Reaction Products

A suspension of 3 g of soybean protein in 100 ml of 45° C. water was formed, 0.06 g of commercial peptidase was added, and a proteolytic liquid was obtained by agitating for approximately 3 hours. Protease P Amano G (Amano Enzyme Inc.) was used for the protease. To this was added 25 g or 50 g of commercial maltose syrup (DE47, 75% solids), glucose syrup (75% solids), or fructose syrup (75% solids) and heating was carried out in a sealed vessel; from the point where it reached 100° C., 115° C. or 120° C., it was maintained for 30 minutes or 60 minutes under a resulting pressure of 0 MPa at 100° C., 0.07 MPa at 115° C., and +0.1 MPa at 120° C. and then removed at that point, and the Maillard reaction products were obtained.

The Maillard reaction conditions in this embodiment, an analysis of the Maillard reaction products obtained, and results of sensory evaluations (by six people) are given in Table 1. “Caramel sense” here is primarily an olfactory characteristic, and it expresses a burned flavor that is accompanied by sweetness, which is sensed strongly in beer in which caramel malt is used.

The GC-MS (Gas Chromatography-Mass Spectrometry) described in AGRICULTURAL and FOOD CHEMISTRY 2003, 51 6941-6944, whose contents are incorporated by reference herein, was used to analyze the aldehydes in the Maillard reaction products or the preparations of the same, that is, to analyze and find the individual concentrations of the furfural component, the methional component, and the phenylacetaldehyde component in the Maillard reaction products or the preparations of the same.

TABLE 1

| | 1 | 2 | 3 | 4 | 5 | 6 | 7 |
|---|---|---|---|---|---|---|---|
| Syrup type | Maltose | | | | | Glucose | Fructose |
| Amount of syrup (g) | 50 | 50 | 50 | 25 | 25 | 25 | 25 |
| Retention temperature | 100 | 115 | 120 | 120 | 120 | 120 | 120 |
| (° C.) | | | | | | | |
| Retention time (minutes) | 60 | 60 | 60 | 60 | 30 | 30 | 30 |
| Retention Pressure (MPa) | 0 | 0.07 | 0.1 | 0.1 | 0.1 | 0.1 | 0.1 |
| Color level (EBC) | 5.8 | 39.5 | 55.8 | 51.5 | 23.8 | 57.4 | 55.7 |
| Furfural (ppb) | 152 | 903 | 2112 | 1203 | 412 | 1090 | 845 |
| Methional (ppb) | 25 | 212 | 512 | 278 | 124 | 1056 | 582 |
| Phenylacetaldehyde (ppb) | 102 | 793 | 1817 | 1289 | 645 | 1587 | 1542 |
| Caramel sense | None | Medium | Strong | Medium | Weak | Strong | Strong |

Under the conditions of this embodiment (the same proteolytic liquid, 120° C. or less), the amounts of the aldehydes produced that are believed to be products of the Maillard reaction (furfural, methional, and phenylacetaldehyde) correlated substantially with the color level measured. When these analytic values were viewed as a proxy index of the strength of the Maillard reaction, it was found that the effect of temperature on the Maillard reaction strength was large and that the reaction rate was extremely slow at 100° C. compared with at 120° C. Stronger Maillard reaction products were obtained when glucose and fructose syrups, which have monosaccharides as the main components, were used than with maltose syrup, which has disaccharides or higher saccharides as the main components. On the other hand, as a result of sensory evaluations with the caramel sense, which is one of the aromas sensed specifically in Maillard reaction products, as the proxy index, the results were that the flavor obtained by the Maillard reaction was substantially proportional to the color level and the amounts of aldehydes produced, namely, furfural, methional, and phenylacetaldehyde. Therefore, under these conditions, it was made clear that there was no problem in evaluating the strength of the Maillard reaction products with the color level or these aldehydes as a proxy index.

### EMBODIMENT 2

### Example of Producing Fermented Alcoholic Beverage

In this embodiment, a “miscellaneous liquor” does not use wheat, barley or their malts was produced. A 2 kL scale test facility was used for the facility where this was carried out.

Ten kg of soybean protein was put into 330 liters of hot water, and protein breakdown was carried out using commercial peptidase. Protease P Amano G (Amano Enzyme Inc.) was used as the protease. Two hundred kg of a commercial maltose syrup (DE47, 75% solids) was added to the proteolytic liquid obtained, the solution was heated in a sealed vessel and maintained for 60 minutes after it reached 120° C. and a pressure of +0.1 Mpa, and a Maillard reaction liquid was obtained. Next, the Maillard reaction products described above were added to hot water containing 200 kg of maltose syrup, the sugar concentration was adjusted to approximately 13° P, and hops were added; after boiling for approximately 1 hour, it was cooled to approximately 10° C., yeast was added, and fermentation was carried out. After approximately 1 week of fermentation and several weeks of aging, the alcohol concentration was adjusted to 5.5 v/v %, and a fermented alcoholic beverage (an “other miscellaneous liquor”) was obtained. On the other hand, 400 kg of maltose syrup and 1.6 kg of caramel color were added to the same proteolytic liquid of soybean protein, the solution was adjusted to approximately 13° P, hops were added, boiling was carried out for approximately 1 hour, and a control product (an “other miscellaneous liquor”) that did not use Maillard reaction products was obtained by carrying out the same operations as described above thereafter. The proteolytic products of soybean are fed into the Maillard reaction process in their entirety (10 kg) while for maltose, only half of it (200 kg) is added before the process, with the other half (200 kg) being held off until fermentation. This is done in order to properly control the Maillard reaction. The amount of sugar input needs to be controlled because an excess amount of sugar speeds up the Millard reaction drastically, making it difficult to control. Additionally, to add a large amount of sugar, a bigger autoclave (container, pot) is needed.

The results of the analysis of the fermented alcoholic beverage of the present invention and the control product obtained are given in Table 2, and the results of the sensory evaluations (by six people) are given in Table 3. It was found that by using the Maillard reaction products of the present invention effectively and efficiently, it was possible to achieve a liquid color and flavor that were the same as those of normal beer and “low-malt beer” with malt content close to 66.7%. ?) In one actual example the components are: furfural 16.48 ppb, methional 0.81 ppb, phenylacetaldehyde 2.76 ppb with malt content of 24%), These components can not be achieved by using colorings such as caramel. In other words, it was found that the fermented alcoholic beverage produced by the method according to the present invention had a color level of 5-15 EBC, and the furfural component adjustable within the range of 13-18 ppb, the methional component within 1.0-2.2 ppb, and the phenylacetaldehyde component within 10-16 ppb, respectively. The range was determined by experiments to achieve the flavor closest to beer. The “caramel sense” in Table 3 is primarily an olfactory characteristic, and it expresses a burned flavor that is accompanied by sweetness, which is sensed strongly in beer in which caramel malt is used. As can be seen from the results in the tables below, fermented alcoholic beverages brewed without using barley, wheat or their malts lack flavor and a feeling of body as they are and come out to taste thin, but by using the Maillard reaction products, the caramel sense (the flavor sensed when caramel malt is used) and sweetness were increased, and a product that was mild and had a feeling of body was successfully produced. In addition, the appearance was also characterized by brightness and a good color tone when compared with those colored by caramel color. These characteristics were close in their tendency to beer in which 70% of the total ingredients used is malt, and the characteristics were natural with no peculiar smell.

TABLE 2

| | Embodiment 2 | Control | Beer¹ |
|---|---|---|---|
| Color level (EBC) | 8.9 | 8.2 | 7.5 |
| Furfural (ppb) | 16.33 | 10.53 | 16.02 |
| Methional (ppb) | 1.49 | 0.52 | 2.04 |
| Phenylacetaldehyde | 12.78 | 3.93 | 13.13 |
| (ppb) | | | |

¹Reference: MALTING and BREWING SCIENCE Volume 2 HOPPED WORT and BEER J. S. Hough, D. E. Briggs, R. Stevens, and T. W. Young, “Malting and Brewing Science, Volume 2, Hopped Wort and Beer,” second edition, Aspen Publishers, Inc. (1999).

TABLE 3

| | Embodiment 2 | Control | Beer |
|---|---|---|---|
| Appearance | Bright golden | No brightness and | Bright golden |
| | yellow with a | somewhat darkened | yellow with |
| | touch of somewhat | | brightness |
| | red color | | |
| Maltiness | Has a flavor | None | Plenty |
| | that is close | | |
| Caramel | 4 | 1 | 3 |
| sense | | | |
| Sweetness | 4 | 1 | 3 |
| Mildness | 4 | 2 | 4 |
| Feeling of | 3 | 2 | 5 |
| body | | | |

According to the method for producing a fermented alcoholic beverage of the present invention that uses Maillard reaction products, it is possible to produce a fermented non-“beer” alcoholic beverage that is imparted a beer-like, natural color level and flavor even in producing fermented alcoholic beverages such as “low-malt beer” and “other miscellaneous liquors” that require enhancement of the color level and flavor of the fermented alcoholic beverage because of restrictions on the use of fermentation ingredients such as the use of barley, wheat or their malts. It is possible to produce a fermented non-“beer” alcoholic beverage excellent in liquid color and flavor and having the flavor and feeling of body that exist in beer.

What is claimed is:

1. A fermented alcoholic beverage excellent in liquid color and flavor, the fermented alcoholic beverage comprising:
a color level of 5˜15 EBC; and
a methional component of at least 1.0 ppb;
wherein the fermented alcoholic beverage is produced by use of brewer's yeast and the liquid color and flavor of the fermented alcoholic beverage is adjusted by using Maillard reaction products of sugar and proteolytic products and a preparation of the Maillard reaction products.

2. A fermented alcoholic beverage excellent in liquid color and flavor, the fermented alcoholic beverage comprising:
a color level of 5˜15 EBC; and
a phenylacetaldehyde component of at least 10 ppb;
wherein the fermented alcoholic beverage is produced by use of brewer's yeast and the liquid color and flavor of the fermented alcoholic beverage is adjusted by using Maillard reaction products of sugar and proteolytic products and a preparation of the Maillard reaction products.

3. The fermented alcoholic beverage of claim 1, further comprising a phenylacetaldehyde component of at least 10 ppb.
